(19) United States
(12) Patent Application Publication
(10) Pub. No.: US 2013/0262453 A1
(43) Pub. Date: Oct. 3, 2013

(54) Estimating Thread Participant Expertise Using A Competition-Based Model

(71) Applicants: Chin-Yew Lin, Beijing (CN); Young-In Song, Beijing (CN); Jing Liu, Beijing (CN)

(72) Inventors: Chin-Yew Lin, Beijing (CN); Young-In Song, Beijing (CN); Jing Liu, Beijing (CN)

(73) Assignee: Microsoft Corporation, Redmond, WA (US)

(21) Appl. No.: 13/430,928

(22) Filed: Mar. 27, 2012

(51) Int. Cl. G06F 17/30

(52) U.S. Cl. 707/723; 707/E17.014

(57) ABSTRACT

The subject disclosure is directed towards ranking participants in an online platform according to expertise. A competition-based metric is applied to question and answer threads in order to model each thread as a set of comparisons between various groups of the participants. After aggregating comparison results for the question and answer treads, one or more relative expertise scores may be estimated for each participant. Each relative expertise score may correspond to a specific category of questions.

### BACKGROUND

People often rely upon Internet resources as providers of various information including answers to personal questions. Some Internet resources provide web-based platforms hosting question and answer threads, which may refer to a sequence comprising a question followed by one or more answers to the question. Example platforms include question and answer services/forums, social networks and/or the like. One or more participants (e.g., questioner or answerer) to these question and answer threads may constitute an online community in which each participant is associated with a member identity. These platforms have become important virtual spaces where people can publish questions to the online community, such as Microsoft® Answers®, seeking advice and/or opinions from other people who may have relevant knowledge and/or personal experiences.

When a questioner posts a question to the online community, other participants often respond with answers ranging in a wide array of expertise. Occasionally, a certifiable expert may supply apt and helpful information, but in most cases, the questioner is unaware as to whether such information is coming from an actual expert or a novice. For example, the questioner cannot determine whether an answerer provided answers to other questions in a same or similar category. Any number of techniques may be employed to estimate the participant expertise, such as those based a number of answers per participant, answer quality and/or participant interaction, such as link analysis-based approaches that focus on co-occurrence between questioners and answerers. The link analysis-based approaches do not estimate participant expertise particularly accurately.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards generating relative expertise scores for participants to question and answer threads. In one aspect, an online platform receives questions from the participants and, after filtering the questions according to various criteria, publishes the questions as threads. In an example thread, the question is followed by one or more answers of which each answer may reflect any level of expertise. When the questioner selects an answer that indicates at least a threshold capacity of relevant requisite skills, knowledge and/or experience on the part of the answerer, it may be assumed that the answerer has a higher expertise level than the other participants including the questioner. After a sufficient number of question and answer threads, an example participant's expertise level may approximate an actual relative expertise score.

Hence, the question and answer thread may be modeled as a set of competitions between the participant with the selected answer—a winning party—and any other thread participant including the questioner. Win-loss results from the set of competitions may be aggregated with win-loss results from other question and answer threads of which the aggregated win-loss results may be used to compute the related skill levels for at least the thread participants. In one aspect, the related skill levels may be used as estimates of the relative expertise scores. In one aspect, the relative expertise scores may be adjusted using answer quality information associated with each selected answer. For a particular participant, individual relative expertise scores may be computed for different question categories.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an example system for performing expertise ranking for an online platform according to an example implementation.

FIG. 2 is a flow diagram illustrating example steps for ranking participants corresponding to an online community according to an example implementation.

FIG. 3 is a flow diagram illustrating example steps for computing relative expertise scores from pair-wise competitions between participants in an online community according to an example implementation.

FIG. 4 is a block diagram representing example non-limiting networked environments in which various embodiments described herein can be implemented.

FIG. 5 is a block diagram representing an example non-limiting computing system or operating environment in which one or more aspects of various embodiments described herein can be implemented.

### DETAILED DESCRIPTION

Various aspects of the technology described herein are generally directed towards ranking participants in an online platform using a competition-based metric. According to one example implementation, a mechanism may apply the competition-based metric to thread data, which represents each thread (e.g., a question-answer thread) as a set of comparisons within various groups of the participants. Using a set of comparison results for each thread, the mechanism may determine a related skill level, observed thus far, for each thread participant. A degree to which the mechanism correctly estimated the related skill level may be known as a certainty (e.g., percentage). Based on the certainty and the related skill level estimates, the mechanism, such as a ranking mechanism, may assign relative expertise scores and classify the participants accordingly.

It should be understood that any of the examples herein are non-limiting. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computing and thread participant evaluation in general.

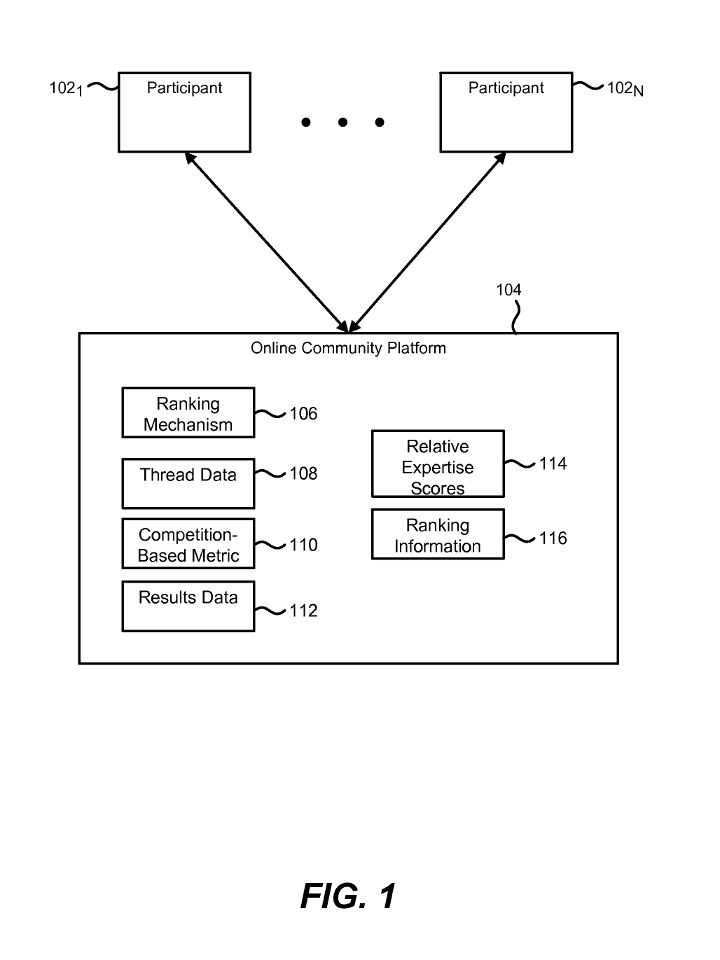

FIG. 1 is a block diagram illustrating an example system for performing expertise ranking for an online platform according to an example implementation. Components of the example system may include a plurality of participants 102_{1 . . . N} and an online platform 104. The plurality of participants 102_{1 . . . N} (illustrated as the participant 102₁ . . . the participant 102_{N}) may herein after be referred to as the participants 102. The online platform 104 may include a configuration of various computing devices (e.g., physical or virtual servers) that exchange data with the participants 102 via information network technology.

Each of the participants 102 may correspond to an electronic identity in use at the online platform 104. According to one example implementation, the online platform 104 and the participants 102 may comprise a social and/or information network. The participants 102 may view and/or communicate with each other through threads, such as question-answer threads. In an example question-answer thread, one participant, known as a questioner, publishes a question to which one or more other participants, each known as answerer, publishes a suggested answer. Within a pre-determined time period (e.g., a fixed number of days) after posting the question, the questioner may select a particular suggested answer for being a high quality response or best response. By way of example, the questioner may post a biology-related question, resulting in five answers being received, out of which the questioner may declare one answer to be the most accurate and most competent.

The online platform 104 may include various software components, such as a ranking mechanism 106 that analyzes each thread (e.g., each question-answer thread). The threads may be stored in thread data 108 and modeled as a set of comparisons within various groups of the participants 102. Based on such an analysis, the ranking mechanism 106 may group (e.g., sort) the participants 102 according to expertise, which may be indicated by corresponding information posted in at least one thread. For example, the ranking mechanism 106 may instrument any known automatic answer quality prediction mechanism to return answer quality indicia for each participant post in the thread data 108.

The ranking mechanism 106 may apply a competition-based metric 110 to the thread data 108 to identify the set of comparisons between pairings of the participants 102. In one example implementation, the set of comparisons may include a set of competitions for modeling an example question-answer thread where the participant with a selected answer may be compared with each other participant in the example thread including each non-selected answerer and/or the questioner. For each competition, the ranking mechanism 106 may label the participant with the selected answer as a winning party and may label the other answerer or the questioner as a losing party according to one example implementation. The ranking mechanism 106 may create results data 112 that stores an aggregation of labels over a number of question-answer threads for at least a portion of the participants 102.

By way of example, the results data 112 may reflect a win-loss record for each participant associated with at least one competition. As described herein, the ranking mechanism 106 may employ any number of competition-based techniques to the results data 112 and generate relative expertise scores 114 for at least some of the participants 102. According to one example implementation, the ranking mechanism 106 may model probabilities (e.g., posterior probabilities) for one or more expected related skill levels after a proposed competition outcome for one or more of the participants 102. According to one alternative example implementation, the ranking mechanism 106 may apply a maximum-likelihood estimation approach (also known as likelihood maximization) to the results data 112 for computing the relative expertise scores 114. Note that other implementations for computing the relative expertise scores 114 may utilize any appropriate model parameter estimation approach.

By adapting various techniques employed for determining a quality of each opponent in a multi-player competition (e.g., opponents in two-player games, such as chess), the ranking mechanism 106 may quantify the related skill levels. According to one such technique known as the “Elo rating system”, victories and losses may translate into rewards and penalties, respectively, based on the relationship between competing pairs of the participants 102. The ranking mechanism 106 may modify a participant's related skill level based on such rewards and/penalties. After a certain number of competitions, each participant's related skill level more accurately reflects his/her expertise amongst at least a portion of the participants 102.

Head-to-head competition results may be used to update the related skill levels (e.g., current or starting values), which in one implementation may be performed using standard or modified “Elo” formulas in an update rule. For example, consider a competition between a first participant (A) and a second participant (C) where A wins against C. In an Elo-based system, related skill levels, R(A) and R(C), are updated for this pairing using equations (1)-(2) as follows (where e is a random variable, for example, between zero (0) and ten (10) and c refers to a certainty):

$$\begin{matrix}R ( A ) ← R ( A ) + c \times \frac{{e}^{R ( C ) - R ( A )}}{1 + {e}^{R ( C ) - R ( A )}} & ( 1 ) \\ R ( C ) ← R ( C ) - c \times \frac{{e}^{R ( C ) - R ( A )}}{1 + {e}^{R ( C ) - R ( A )}} & ( 2 )\end{matrix}$$

Other techniques may be applied to multi-participant competitions. In one example implementation, the “Elo” rating system may be altered to suit an example multi-participant competition in which each participant is compared with each other participant over a set of pair-wise competitions. The ranking mechanism 106 may also implement a Bayesian skill level rating model, which extends the Elo rating system with a dynamic variance and/or may incorporate the concept of a tie or draw when estimating the related skill levels. After each comparison, the ranking mechanism 106 may adjust each participant's related skill level in response to actual and expected skill levels for each participant. The ranking mechanism 106 may combine these adjustments and modify a corresponding related skill level (e.g., a previous or starting related skill level) for each participant.

The Bayesian skill level rating model may assume that the performance of each participant in an example competition follows a normal distribution including a mean μ (e.g., an average skill level) and a standard deviation σ. The standard deviation σ may represent an uncertainty, within this model, associated with estimating the related skill level. As the results data 112 size increases with more competitions, the ranking mechanism 106 updates the Bayesian skill level rating model with a more certain related skill level estimate, which causes a decrease in the standard deviation σ.

In one example implementation, the ranking mechanism 106 may use the Bayesian skill level rating model to estimate the related skill levels of the participants 102 where each related skill level may constitute a class. The ranking mechanism 106 may execute a function to process a win-loss result and return a related skill level estimate (e.g., a prior estimate) having a highest current certainty (e.g., a prior probability). The Bayesian skill level rating model may express the current certainty of the related skill level estimate as a standard deviation or variance, such as a dynamic variance.

Based on an effect of a potential win or loss to the current certainty of the related skill level estimate, the ranking mechanism 106 may generate a new estimate of the related skill level, which may be based upon an updated certainty (e.g., a posterior probability) of the related skill level estimate. By way of example, the new estimate may be a maximum a posteriori probability (MAP) estimate, which is computed using (e.g., a mode of) a posterior probability distribution. If the current certainty changes to a point where another related skill level is most likely a more accurate estimate, the ranking mechanism 106 selects the other related skill level as an embodiment of a relative expertise score.

The effect of the potential win on a certainty of the related skill level estimate may refer to multiplicative factor, such as a likelihood, which may be measured as a probability of an answer, which is selected by the questioner, being published by a first participant with the related skill level estimate over a second participant with another skill level estimate. The ranking mechanism 106 may approximate the likelihood using an expected comparison result between the first participant and the second participant, which may be represented as a ratio between respective relative skill estimates. The expected value may be applied to the current certainty to compute the updated certainty. In one example, the likelihood may be computed using a question and answer thread that included a specific opposing participant. In another example, the likelihood may be computed using question and answer threads for a certain category comprising same or similar questions.

The Bayesian skill level rating model may assume that the related skill level of each participant most likely changes after each competition, which enables tracking of skill improvement over time and ensures that the standard deviation σ most likely does not decrease to zero (0). The related skill levels may be initialized to pre-determined values for the mean μ and the standard deviation σ. After completing each competition, the related skill level of a participant i may be computed as an estimate given by the one (1) percent lower quantile μᵢ−3σ₁, which permits the ranking mechanism 106 to effectively rank the participants 102 and identify one or more highly skilled ones with statistical certainty.

To initialize a process for updating related skill level estimates, the ranking mechanism 106 may model a question-answer thread as a set of competitions. According to one example competition, a first answerer is an experienced expert participant associated with a small standard deviation, indicating certainty with respect to skill level; whereas, a second answerer is a new player with a larger standard deviation, indicating an uncertain skill level. If the ranking mechanism 106 designates the answer provided by the second answerer as a selected answer, the Bayesian skill level rating model significantly updates an average skill of the second answerer. The ranking mechanism 106 may consider that the second answerer has more expertise than the first answerer in view of the outcome. The second answerer, nonetheless, retains the larger standard deviation due to the uncertainty over the skill level after only one question-answer thread.

Equations to update the related skill levels of the participants 102 and the uncertainty about estimation are as follows:

$$\begin{matrix}{μ}_{winner} = {μ}_{winner} + \frac{{σ}_{winner}^{2}}{c} \cdot v ( \frac{t}{c} , \frac{ɛ}{c} ) & ( 3 ) \\ {μ}_{loser} = {μ}_{loser} + \frac{{σ}_{loser}^{2}}{c} \cdot v ( \frac{t}{c} , \frac{ɛ}{c} ) & ( 4 ) \\ {σ}_{winner}^{2} = {σ}_{winner}^{2} \cdot [ 1 - \frac{{σ}_{winner}^{2}}{c} \cdot w ( \frac{t}{c} , \frac{ɛ}{c} ) ] & ( 5 ) \\ {σ}_{loser}^{2} = {σ}_{loser}^{2} \cdot [ 1 - \frac{{σ}_{loser}^{2}}{c} \cdot w ( \frac{t}{c} , \frac{ɛ}{c} ) ] & ( 6 )\end{matrix}$$

In these equations, the variable t reflects the expectations on the outcome of a comparison where t is positive when the outcome is expected and t is negative when the outcome is unexpected. The variable c represents an uncertainty (e.g., a complement of certainty) and variable ε represents a probability of a draw between two or more answerers. If only one answer may be selected as the selected answer, the variable ε is removed from the above equations or set to zero (0).

The functions v(t, ε) and w(t, ε) are weighting factors to average skill μ and standard deviation σ, respectively, and reflect the assumptions about updating μ and σ. The following equations define these variables in which N is a standard normal distribution, φ is a cumulative normal distribution and β is a parameter representing a related skill level range and used to set a variance:

t=μ_{winner}−μₗₒₛₑᵣ (7)

c²=2β²+σ_{winner}²+σₗₒₛₑᵣ² (8)

v(t,ε)=N(t−ε)/φ(t−ε) (9)

w(t,ε)=v(t,ε)·(v(t,ε)+t−ε) (10)

As an alternative, the ranking mechanism 106 may employ a maximal likelihood approach to learn the relative expertise scores 114. Ranking the participants 102 may be reduced to an optimization problem of which the ranking mechanism 106 may solve using a (e.g., linear) support vector machine model as follows:

$${min}_{i ∈ n} \frac{1}{2} {‖ θ ‖}^{2} + C \sum {ξ}_{k} \qquad ( 11 )$$

The above equation may be subject to the following conditions:

yₖ( [symbol] θ,xₖ [symbol] )+b)≧1−ξₖ; ξₖ≧0 (12)

The relative expertise scores 114 may be represented as θ={θ₁, . . . , θₙ} where of each of the participants 102 may correspond to a relative expertise score of θᵢ. The variable ξₖ represents a slack variable in a standard soft margin support vector machine model. The variable xₖ is a vector of length n associated with a pair-wise competition k, and y is the win-loss result. Given a two-player competition k having a winning participant i (e.g., an selected answerer) and a losing participant j (e.g., another answerer or a questioner) the ranking mechanism 106 generates the following two training instances:

yₖ=1,xₖ[i]=1,xₖ[j]=−1 (13)

y′ₖ=0,x′ₖ[i]=−1,x′ₖ[j]=1 (14)

The vector \hat{θ}={\hat{θ}, . . . , \hat{θ}} that minimize equation (11) constitute a certain estimate of the relative expertise scores 114.

After generating the relative expertise scores 114, the ranking mechanism 106 may define various forms of ranking information 116 according to one example implementation. The ranking mechanism 106 may create different categories of subject matter for which each of the participants 102 may have a number of expertise levels. Each category, for instance, may refer to a different scientific discipline, such as “physics”, “biology”, “engineering” and/or the like. A more fine-grained list of categories may include specialized fields within a broader scientific discipline, such as “nuclear physicists”, “astrophysicists”, “quantum physicists” and/or the like.

Prior to publishing a question, the questioner may select a category that may match the question's subject matter. The ranking mechanism 106, according to one example implementation, may filter the thread data 108 to extract question-answer threads associated with a specific subject matter category and proceed to identify one or more experts having sufficient relative expertise. The ranking mechanism 106 may produce the relative expertise scores 114 using win-loss results from only the extracted question-answer threads. Hence, the participants 102 may be ranked differently with respect to the expertise associated with each subject matter category.

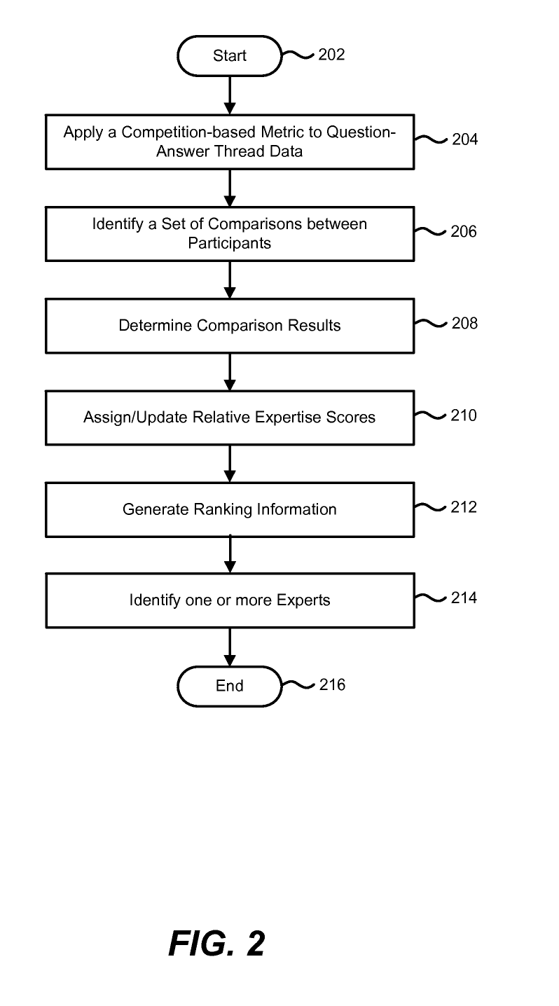

FIG. 2 is a flow diagram illustrating example steps for ranking participants corresponding to an online community according to an example implementation. One or more of the example steps may be performed by the ranking mechanism 106 of FIG. 1. The example steps commence at step 202 and proceed to step 204 at which the ranking mechanism 106 applies a competition-based metric to question-answer thread data.

Step 206 is directed to an identification of a set of comparisons between participants for each question-answer thread. Step 206 may process a single question-answer thread or multiple question-answer threads over a period of time. For an example question-answer thread, the competition-based metric may be used to transform a portion of the set of comparisons into a set of competitions according to one example implementation. Each of the set of competitions may involve an answerer who posted the selected answer and an opponent who is either another answerer or a questioner. It is appreciated that the term “comparisons” may be described interchangeably with the term “competitions”.

Step 208 refers to determining comparison results associated with the set of competitions in each question-answer thread. As described herein, the ranking mechanism 106 may label the selected answerer as the winning party and/or label each opponent (e.g., a non-selected answer or the questioner) as the losing party for each competition. After the ranking mechanism 106 aggregates win-loss results for the question-answer thread(s), step 208 proceeds to step 210. Step 210 starts an assignment of or an update to relative expertise scores to the participants. As described herein, the ranking mechanism may employ numerous approaches, such a Bayesian relative skill rating model, a support vector machine-based classifier and/or the like, to compute the relative expertise scores.

Step 212 represents a generation of ranking information based upon the relative expertise scores. According to one example implementation, the ranking mechanism 106 may partition the comparison results based on question category and filter the relative expertise scores on a category by category basis. Step 214 is directed to an identification of one or more experts. A participant having a relative expertise score that exceeds a pre-defined threshold may be labeled an expert. In one example implementation, such a participant may be considered an expert in a particular category that corresponds to the pre-defined threshold. The example steps illustrated in FIG. 2 terminate at step 216.

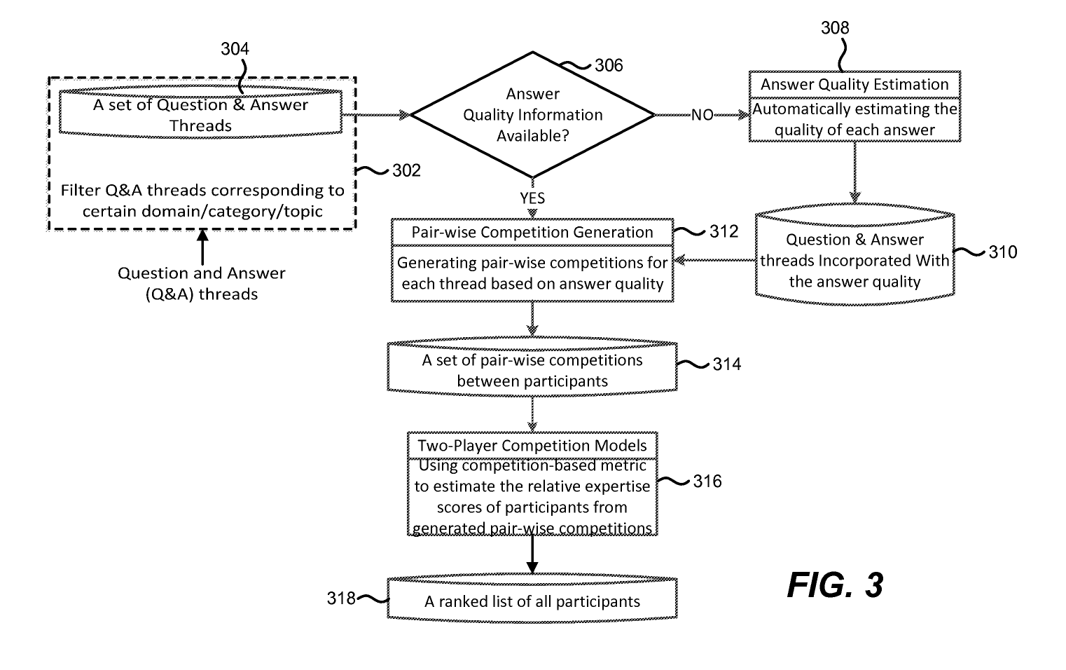

FIG. 3 is a flow diagram illustrating example steps for computing relative expertise scores from pair-wise competitions between participants in an online community according to an example implementation. One or more of the example steps may be performed by the ranking mechanism 106 of FIG. 1. The example steps commence at step 302 at which the ranking mechanism 106 generates a set of question and answer threads 304 and, optionally, proceeds to filter the question and threads corresponding with a certain domain/category/topic. In one example implementation, ranking information (e.g., the ranking information 116 of FIG. 1) may define various categories/domains/topics for identifying one or more experts.

Step 306 determines whether information associated with answer quality is available for the set of the question-answer threads 304. If the answer quality information exists, step 306 proceeds to step 312 at which pair-wise competition generation is performed. If such metadata information does not exist, step 306 proceeds to step 308 at which answer quality estimation is performed. Step 308 refers to automatically estimating the quality of each answer, using any known content quality prediction mechanism, and incorporating the answer quality information into a set of question and answer threads 310.

After updating the set of question and answer threads 304, step 308 proceeds to step 312. Step 312 refers to generating pair-wise competitions of user expertise for each question and answer thread according to the answer quality, which are stored as a set of pair-wise competitions between the participants 314. After generating the pair-wise competitions, the ranking mechanism 106 proceeds to step 316 and creates two-player competition models (e.g., a Bayesian relative skill rating model) by using the competition-based metric to estimate relative expertise scores of the participants from generated pair-wise competitions. The relative expertise scores may be used to sort the participants into a ranked list 318 or the like.

The ranking mechanism 106 may use the ranked list 318 to update participant ranking information in use by the online platform after being brought offline. According to an alternative implementation, ranking mechanism 106 may be directed to automatically deploy the ranked list 318 to the online platform. In such an implementation, the participant ranking information in use by the online platform may be updated while the online platform is actively managing current open question-answer threads.

### Example Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store or stores. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

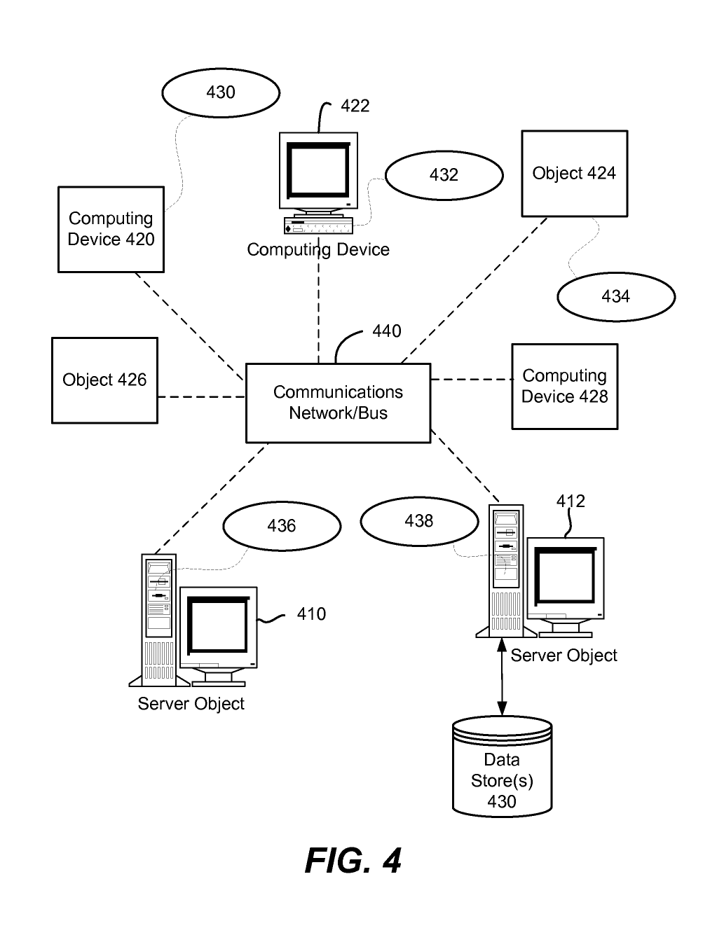

FIG. 4 provides a schematic diagram of an example networked or distributed computing environment. The distributed computing environment comprises computing objects 410, 412, etc., and computing objects or devices 420, 422, 424, 426, 428, etc., which may include programs, methods, data stores, programmable logic, etc. as represented by example applications 430, 432, 434, 436, 438. It can be appreciated that computing objects 410, 412, etc. and computing objects or devices 420, 422, 424, 426, 428, etc. may comprise different devices, such as personal digital assistants (PDAs), audio/video devices, mobile phones, MP3 players, personal computers, laptops, etc.

Each computing object 410, 412, etc. and computing objects or devices 420, 422, 424, 426, 428, etc. can communicate with one or more other computing objects 410, 412, etc. and computing objects or devices 420, 422, 424, 426, 428, etc. by way of the communications network 440, either directly or indirectly. Even though illustrated as a single element in FIG. 4, communications network 440 may comprise other computing objects and computing devices that provide services to the system of FIG. 4, and/or may represent multiple interconnected networks, which are not shown. Each computing object 410, 412, etc. or computing object or device 420, 422, 424, 426, 428, etc. can also contain an application, such as applications 430, 432, 434, 436, 438, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for example communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 4, as a non-limiting example, computing objects or devices 420, 422, 424, 426, 428, etc. can be thought of as clients and computing objects 410, 412, etc. can be thought of as servers where computing objects 410, 412, etc., acting as servers provide data services, such as receiving data from client computing objects or devices 420, 422, 424, 426, 428, etc., storing of data, processing of data, transmitting data to client computing objects or devices 420, 422, 424, 426, 428, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 440 or bus is the Internet, for example, the computing objects 410, 412, etc. can be Web servers with which other computing objects or devices 420, 422, 424, 426, 428, etc. communicate via any of a number of known protocols, such as the hypertext transfer protocol (HTTP). Computing objects 410, 412, etc. acting as servers may also serve as clients, e.g., computing objects or devices 420, 422, 424, 426, 428, etc., as may be characteristic of a distributed computing environment.

### Example Computing Device

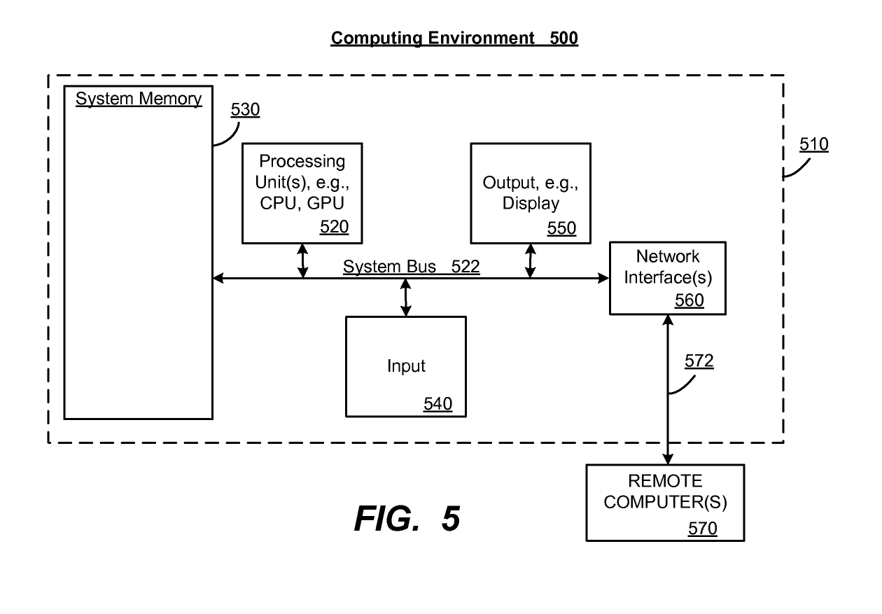

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 5 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 5 thus illustrates an example of a suitable computing system environment 500 in which one or aspects of the embodiments described herein can be implemented, although as made clear above, the computing system environment 500 is only one example of a suitable computing environment and is not intended to suggest any limitation as to scope of use or functionality. In addition, the computing system environment 500 is not intended to be interpreted as having any dependency relating to any one or combination of components illustrated in the example computing system environment 500.

With reference to FIG. 5, an example remote device for implementing one or more embodiments includes a general purpose computing device in the form of a computer 510. Components of computer 510 may include, but are not limited to, a processing unit 520, a system memory 530, and a system bus 522 that couples various system components including the system memory to the processing unit 520.

Computer 510 typically includes a variety of computer readable media and can be any available media that can be accessed by computer 510. The system memory 530 may include computer storage media in the form of volatile and/or nonvolatile memory such as read only memory (ROM) and/or random access memory (RAM). By way of example, and not limitation, system memory 530 may also include an operating system, application programs, other program modules, and program data.

A user can enter commands and information into the computer 510 through input devices 540. A monitor or other type of display device is also connected to the system bus 522 via an interface, such as output interface 550. In addition to a monitor, computers can also include other peripheral output devices such as speakers and a printer, which may be connected through output interface 550.

The computer 510 may operate in a networked or distributed environment using logical connections to one or more other remote computers, such as remote computer 570. The remote computer 570 may be a personal computer, a server, a router, a network PC, a peer device or other common network node, or any other remote media consumption or transmission device, and may include any or all of the elements described above relative to the computer 510. The logical connections depicted in FIG. 5 include a network 572, such local area network (LAN) or a wide area network (WAN), but may also include other networks/buses. Such networking environments are commonplace in homes, offices, enterprise-wide computer networks, intranets and the Internet.

As mentioned above, while example embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the example systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising, ranking participants in an online platform using a competition-based metric, including, applying the competition-based metric to thread data associated with the online platform in which each thread corresponds to a set of comparisons within various groups of the participants, determining comparison results for each participant associated with the thread data, and assigning relative expertise scores to the participants based upon the comparison results.

2. The method of claim 1, wherein assigning the relative expertise scores further comprises computing the relative expertise scores based on a related skill level of each pair of the participants in each comparison.

3. The method of claim 1 further comprising automatically generating answer quality information associated with each answer in a question-answer thread and computing the relative expertise scores based upon the answer quality information.

4. The method of claim 1, wherein determining the comparison results further comprises identifying a selected answer by a questioner in an question-answer thread and generating a set of competitions comprising a participant corresponding to the selected answer and at least one other participant.

5. The method of claim 4 further comprising, for each competition, labeling the participant corresponding to the selected answer as a winning party.

6. The method of claim 4 further comprising labeling each participant associated with a non-selected answer as a losing party.

7. The method of claim 4 further comprising labeling a questioner as a losing party.

8. The method of claim 4 further comprising updating a portion of the relative expertise scores in response to the selected answer.

9. The method of claim 1 further comprising identifying one or more expert participants having a relative expertise score that exceeds a pre-defined threshold.

10. The method of claim 1, wherein assigning the relative expertise scores further comprises computing the relative expertise scores associated with a category of question-answer threads.

11. In a computing environment, a system, comprising, a mechanism configured to model question-answer threads as a set of competitions between participants, the mechanism being further configured to generate results data associated with the set of competitions, to compute related skill levels for each participant in each competition based upon the results data, and to rank the participants based on the related skill levels.

12. The system of claim 11, wherein the mechanism is further configured to process one or more pair-wise competitions between a selected answerer and one or more other answerers and a pair-wise competition between the selected answerer and a questioner for each question-answer thread.

13. The system of claim 11, wherein the mechanism is further configured to estimate a first related skill level for a selected answerer and a second related skill level for a non-selected answerer.

14. The system of claim 13, wherein the mechanism is further configured to update the first related skill level and the second related skill level in response to a comparison between the non-selected answerer and the selected answerer.

15. The system of claim 11, wherein the mechanism is further configured to identify an expert participant in a particular subject matter category.

16. The system of claim 11, wherein the mechanism is further configured to modify the relevant skill levels in response to recent question-answer threads.

17. The system of claim 11, wherein the mechanism is further configured to automatically deploy the related skill levels to an online platform.

18. One or more computer-readable media having computer-executable instructions, which in response to execution by a computer, cause the computer to perform steps comprising:
identifying a set of pair-wise competitions comprising an answerer associated with an selected answer in a question-answer thread;
for each pair-wise competition, labeling the answerer as a winning party and labeling an opponent as a losing party;
generating results data for the set of pair-wise competitions; and
updating a ranked list of participants in use by an online platform based on the results data.

19. The one or more computer-readable media of claim 18 having further computer-executable instructions comprising:
updating related skill levels for each winning party and each losing party in the set of competitions.

20. The one or more computer-readable media of claim 18 having further computer-executable instructions comprising:
labeling a pair-wise competition result between a questioner associated with the question-answer thread and the answerer as a draw.
